(19) United States
(12) Patent Application Publication
(10) Pub. No.: US 2005/0081416 A1
(43) Pub. Date: Apr. 21, 2005

(54) Container storage system and method

(76) Inventor: Douglas Sean Morris, Gastonia, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/689,372

(22) Filed: Oct. 20, 2003

(51) Int. Cl. G09F 3/20; G09F 3/00

(52) U.S. Cl. 40/649; 40/324

(57) ABSTRACT

A container system for storing food or other products is provided comprising a bottom wall and a peripheral wall defining a storage area for receiving the goods, and a display window extending from the outer surface of the peripheral wall. The display window defines a gap for receiving at least one display token. The display token corresponds to information relating to the goods or products stored in the container, and the display token is visible through the wall of the display window.

### BACKGROUND OF THE INVENTION

The food service industry is heavily reliant upon storing food and garnishes in containers that are to be used for storing and presenting the food for consumer consumption. Many types of storage containers are known in the art, such as stainless steel, glass, and polymeric containers that can be stored in refrigerators or freezers, salad bars, steam tables, and the like. The food that is stored in these containers typically has a known spoilage date or lifespan, which may be dictated by federal, state, or local health code regulations. A serious concern is preventing the growth of bacteria that can occur if the food remains in the container past its storage lifetime. The health concerns associated with spoiled food is so great, in fact, that millions of consumers are stricken by illness every year caused by spoiled food, and thousands die every year due to food poisoning. Thus, there is a need to indicate a spoilage date or other information that would provide food service businesses an easy reference for determining when a particular food stored in a container must be thrown away or discarded.

In this regard, various systems and methods of dating food product freshness or spoilage dates are known in the art, particularly in the restaurant business. A typical system for determining the spoilage date of a particular food item, such as guacamole placed in a polycarbonate container, includes placing a color-coded adhesive label on the outside of the container. The adhesive labels are typically known as “day dots,” as the labels are typically color-coded to represent the days of the week. The labels therefore convey information about the food items stored in the container, such as when the food item was made or placed in a container, or how long the food item can remain in the container before being considered spoiled under health code regulations, i.e., a “made on” or “use by” date. For example, if the guacamole has a storage lifespan of two days and the product was placed in the container on a Monday, an adhesive label corresponding to Monday would be placed on the outside of the container to indicate the date the guacamole was made and/or put into the container. Under this system, a food service worker would have to discard the guacamole on or before Wednesday to avoid health code violations as well as potentially harmful bacteria contamination.

There are several disadvantages to this system. Unfortunately, such a system is quite easy to manipulate, such that fraud can occur that puts consumers at risk. Specifically, additional stickers can be easily placed over the original sticker to fraudulently change the original “made on” date of the food item. Such fraud is believed to be rampant in the food service industry and is difficult to prevent or detect during a food service audit. Oftentimes, additional stickers are placed over the original sticker by a food service worker in conjunction with additional food being placed on top of the original food placed in the container, and perhaps mixed together, as the original supply of food is consumed. This practice compounds the problem because the food located at the bottom of the container is mixed with fresh food, and therefore any bacteria that may be present on the original food is mixed into the fresh food. Thus, even fresh food can be contaminated even though it was recently made or placed in the container. Accordingly, there is a need for a system that prevents mixing foods having different “made on” and/or spoilage dates in the same container.

Another disadvantage to the adhesive label food spoilage dating system is that the adhesive labels are difficult to remove, as a label with only limited adhesiveness would come off too easily when the container is placed in hot or cold environments, and particularly when the container is submerged in liquid, such as in a steam table or the like. Thus, the labels often leave a sticky residue on the outer surface of the food container, and the adhesive typically remains on the container even after washing in industrial washer machines. Most heath code regulations forbid such residue after completing an industrial washing, and thus health code violations result unless extra time is spent with solvent or the like to remove the adhesive residue left by the labels. This creates added cost and complexity to the washing process, and also introduces dangerous solvents and other chemicals around food, which is dangerous to consumers and food service workers. Another disadvantage of introducing solvents is that the solvents damage the containers by causing a transparent or translucent container to cloud, which creates a poor visual impression. The clouding is further increased if abrasives are used with the solvent to scrape the adhesive from the container.

Another disadvantage to this system is that the adhesive labels are not reusable, as a majority of the labels are washed off during the industrial washing process or by hand. Because the labels cannot be reused, they are purchased by the thousands on rolls of release paper and are stored in the kitchen area so that the labels can be applied to the hundreds of containers typically found in most food service locations. These rolls of adhesive labels cause a further problem in that the rolls are typically thrown about the kitchen area, with discarded release paper and old labels being discarded randomly and creating a sanitary and visual problem. Therefore, there is a need for a system that provides reusable indicators that do not leave adhesive residues and streamline the efficiency in the kitchen.

### BRIEF SUMMARY OF THE INVENTION

These and other needs are met by the present invention, which provides a reusable display token that is removably inserted into a display window that is attached or integral with the outer surface of a storage container. The display token of the present invention has no adhesives and leaves no residue on the container, and is designed to sink in water such that the token does not float when the token and container are submerged in hot or cold liquids. In addition, the display token cannot be removed from the display window (without considerable effort and/or fraudulent intent) unless the container, and presumably the contents stored therein, are substantially inverted, which prevents mixing of new and old food and discourages fraud. Furthermore, the display token of the present invention can be washed and reused, thereby eliminating waste and improving efficiency.

In particular, one embodiment of the present invention includes a storage pan or container having a bottom wall and a peripheral wall with inner and outer surfaces. The peripheral wall has a bottom end that adjoins the bottom wall, and a top end that may include a lip or flange so that the container can be placed in a buffet table or steam table. The bottom wall and peripheral wall define a storage area for receiving food, although other substances, such as chemicals and the like, may be stored in the container. A display window is attached or integral with the peripheral wall. The display window has a wall that is spaced away from the outer surface of the peripheral wall to define a gap therebetween. In one embodiment, the gap is large enough to receive a display token that is color-coded according to the days of the week or other such corresponding information. The bottom wall, peripheral wall, and display window may be selected from one or more materials, including stainless steel, aluminum, glass, polyethylene, polycarbonate, and other polymeric materials. In a preferred embodiment, the container and the display window are transparent or translucent, such that the food stored in the container can be seen through the peripheral wall, and the display token can be seen through the display window. The wall of the display window may also have an opening, such as slit or the like, so that the display token can be seen therethrough. The display window may also define a drainage channel that is communication with the gap defined by the display window and the peripheral wall, so that water that is introduced into the gap defined by the storage window and the peripheral wall can drain through the drainage channel. In an alternative embodiment, the peripheral wall includes a flange portion that extends outwardly, and the display window extends from the flange portion of the peripheral wall. Preferably, however, the display window is located on a side of the container along the peripheral wall about midway between the top end and bottom end of the peripheral wall.

The display token can have many shapes and sizes, such as round, polygonal and elliptical, and can convey different information depending on the particular use. In one embodiment, seven display tokens are provided wherein each token corresponds to a respective day of the week. Preferably, the display token is double-sided so that the token can display information through the display window regardless of its orientation. The token can be formed from many different materials, including polymeric and metallic materials. In one embodiment, the display token has a thickness of about two millimeters, and the gap defined by the display window and the peripheral wall is approximately the same distance, such that only one display token can fit inside the display window. The display window can also be angled somewhat from the peripheral wall in order to ease installation and removal of the display token.

Methods of storing goods are also provided by the present invention. One method includes storing goods in a container, selecting a display token corresponding to a “made on” or “use by” date, and inserting the display token in a display window positioned on an outer surface of the container such that the display token is visible through the display window. The selecting step may include determining the expiration date of the goods based upon a predetermined rate of spoilage or the like, and then selecting a color-coded display token corresponding to the expiration date. Once the display token is inserted into the display window, the display token is visible through the wall of the display window so that the information can be conveyed readily. The display token and container can then be at least partially submersed in water or liquid, yet the display token is retained by the display window or otherwise remains in the display window while submerged.

Accordingly, the system and methods of the present invention provide substantial improvements in the art, including eliminating adhesive residues left by disposable labels, increasing the efficiency and lowering costs, preventing fraud, and extending the lifetime of storage containers. The display tokens of the present invention also provide a reusable device for conveying information about a food product or other product stored within a container that can be washed and reused.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a storage container according to one embodiment of the present invention;

FIG. 2 is a front elevation view of a storage container according to one embodiment of the present invention;

FIG. 3 is an enlarged side elevation view of a storage container according to one embodiment of the present invention;

FIG. 4 is a top plan view of a plurality of display tokens according to one embodiment of the present invention; and

FIG. 5 is a top plan view of a plurality of display tokens according to the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

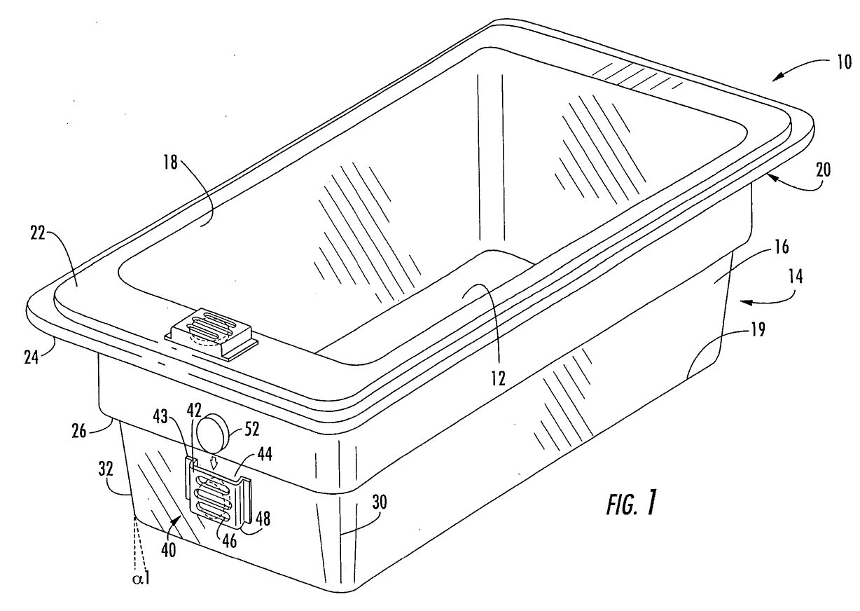

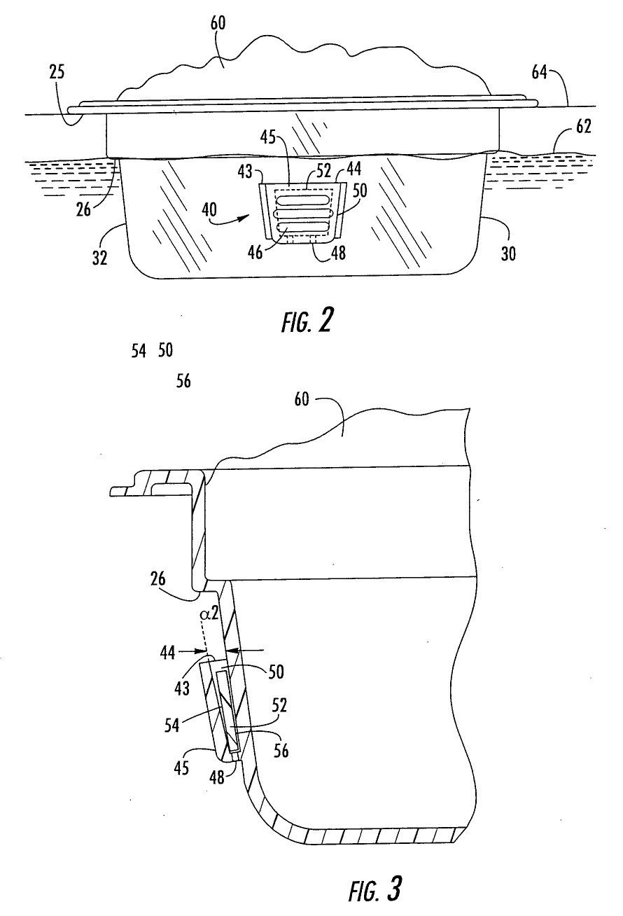

Turning now to the figures, FIGS. 1 and 2 show a container 10 for storing goods or products according to the present invention. The container 10 is formed by a bottom wall 12 and a peripheral wall 14 that can form one of a plurality of shapes, including polygonal, round, and elliptical, but preferably is formed into more conventional square or rectangular shapes. The peripheral wall 14 has an outer surface 16 and an inner surface 18 to define the storage area for receiving products 60, such as food products, chemicals, or other goods. The peripheral wall 14 also has a bottom end 19 that meets the bottom wall 12 and a top end 20. The top end 20 may include a flange 22 having a distal edge 24 that defines a lower surface 25. In this regard, the container 10 may be placed in a buffet or steam table having a surface 64 and defining an opening corresponding to the shape of the container so that the lower surface 25 of the container rests against the surface of the table while the peripheral wall extends down into the table, such as at least partially below a water level 62 held inside the table. It is also possible that the container 10 may be used in conjunction with a lid (not shown), as is known in the art.

As mentioned above, the peripheral wall 14 is preferably in the form of a square or rectangle having a plurality of sides defined by edges, such as side edges 30 and 32. In one embodiment, the peripheral wall 14 is tapered between the top end 20 and bottom end 19 to define an angle α1, whereby a planar cross section of the peripheral wall proximate the bottom end 19 has a smaller area than a corresponding cross section proximate the top end 20. As such, the container 10 may be stackable. In addition, a lip 26 may also be formed along a portion of the peripheral wall 14 to aid in stackability, container placement, or ease of handling.

The container 10 is preferably formed of polycarbonate materials, such as LEXAN® polycarbonate resin from GE Plastics. Other high performance plastics may also be used, such as polyethylene. Further, the container 10 may be formed of stainless steel, aluminum, or other metals. Preferably, the container 10 is transparent or translucent so that the products or goods stored therein can be seen through the peripheral wall 14. Such containers are known in the art and are described in various references, such as U.S. Pat. No. 5,676,276 to Zielinski et al.

FIGS. 1-3 show one embodiment of the container 10 having a display window 40 according to the present invention. In particular, the display window 40 includes a wall 42 that is spaced from the peripheral wall 14 to define a gap 44 therebetween. In one embodiment, the gap 44 is no greater than the lip 26 extending from the peripheral wall 26, such that the stackability of the container is not affected. The wall 42 can be transparent, translucent, or opaque, and in one embodiment defines an opening or slit or slits 46. Accordingly, it is possible to see through the wall 42 itself, the opening 46 thereof, or both. While the slits 46 represent one embodiment for an opening, other shapes and configurations are possible, such as circular, polygonal, or other geometric shapes. The display window 40 may include sidewalls 50 and be attached to the outer surface 16 of the peripheral wall 14, such as between side edges 30, 32. Suitable attachment means can be used, such as adhesives, connectors, screws, and the like. Alternatively, the display window 40 may be formed integrally with the peripheral wall 14 and have sidewalls and/or a more rounded or smooth overall shape. In one embodiment, the wall 42 forms an angle α2 with the peripheral wall such that the gap 44 is greater proximate a top end 43 than a bottom end 45 of the wall 42. However, the gap 44 may be consistent between the top end 43 and the bottom end 45. In addition, the display window 40 defines at least one drainage channel 48 that is adapted for allowing liquid to pass therethrough. Other locations for the display window 40 are also possible, such as on the flange 22 of the peripheral wall 14 (see FIG. 1). It is also possible that the container 10 includes more than one display window. However, this is less advantageous when the container is used in conjunction with food products because confusion may result if conflicting information is presented by or in the display windows 40. However, when the container is used in conjunction with chemicals, having more than one display window may be beneficial, as discussed below.

A display token 52 is also provided and can be inserted into the open top end 43 of the display window 40. The display token 52 has a first side 54 and a second side 56, and is preferably formed of a polymeric or metallic material. The display token 52 according to one embodiment is about 2 millimeters, although the thickness can be greater or less than 2 millimeters. Preferably, the display token 52 has a density greater than water, such that the display token will sink when submerged in water in a food buffet or steam table. As shown in FIG. 2, the display window 40 and the display token 52 may have corresponding and complementary shapes and sizes to assist in placement of the token in the display window and improved aesthetics. The opening 46 defined by the wall 42 allows a user to see and identify information presented by the display token 52, which may also occur if the wall 42 is transparent or translucent.

The display token 52 can have a unique identifier that may include color, text, shape, or combinations thereof. As such, various information can be associated with each display token 52, similar to how adhesive labels, e.g., “day dots,” are used in conventional systems, such as production date, expiration date, and “use by” date. Other information can also be associated directly or indirectly with the display token 52, such as chemical interaction, warnings, product groupings, temperature or storage directions, and other such information

It is also possible that the display window 40 is located on the inside surface 18 of the peripheral wall 14 so that the display token 52 is visible through the peripheral wall itself. Food or other products can then be placed within the container 10, and would further discourage fraud by making it more difficult to remove the display token unless the food or other products are removed or dumped from the container.

As discussed above, only one display window 40 is preferable when used in conjunction with food products in order to avoid confusion about the production date of the food products stored in the container 10. However, in some chemical applications it is advantageous to indicate not only the production date of the chemicals stored in the container, but also the expiration date of the chemicals, as this may not be readily apparent. In this case, having two display windows 40 would be beneficial.

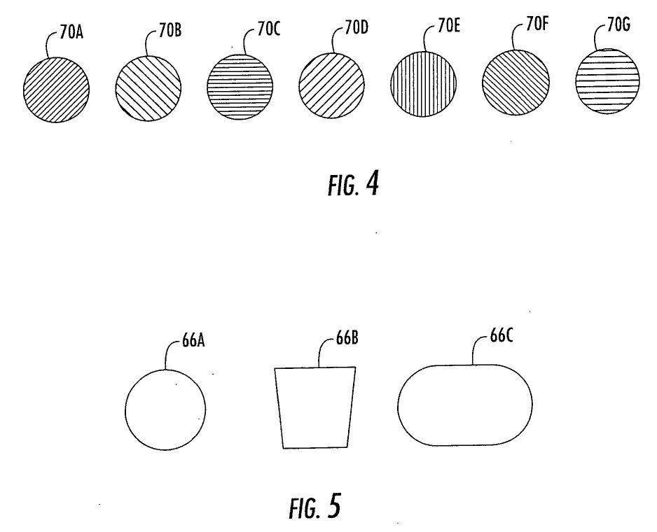

FIGS. 4 and 5 show various embodiments of a display token according to the present invention. FIG. 4 shows one embodiment of the present invention wherein the display token includes seven different tokens 70A-70G that correspond to the days of the week. The tokens 70A-70G may be color-coded or otherwise identified to convey particular information about the goods or products located in the container 10. In addition, the tokens may be double-sided so that the tokens can be inserted into the display window 40 in any orientation and a user would be able to quickly recognize the information conveyed by the token. FIG. 5 shows various configurations of a display token, including round 66A, polygonal 66B, and elliptical 66C. Note that while only one polygonal shape is shown in FIG. 5, other multi-sided polygonal shapes are within the scope of the invention. The same is true for the elliptical shape shown in FIG. 5.

To address the fraud descriptions detailed above, the gap 44 defined by the wall 42 is preferably sized so that only one display token 52 fits within the gap. As such, the fraud of covering up one display token with another, which is relatively common in conventional adhesive label systems, is prevented. In addition, the display window 40 and tokens 52 are designed such that the token 52 cannot be easily removed (or removed at all) unless the container 10 is substantially or completely inverted, which significantly deters the fraud of mixing expired products with new products because the contents of the container would be dumped in order to remove the display token. As such, the opening 46 defined by the wall 42 is designed so that a token 52 can be seen therethrough, yet a user cannot manipulate or remove the token, such as by sticking a finger in the opening and raising the token out the top end 43 of the display window 40.

In use, goods or products that have a predetermined lifespan, storage time, or rate of spoilage, which may be ascertained through health code regulations, the proprietor, or the like, are stored in the container 10. According to one embodiment, a display token 52 corresponding to the expiration or “use by” date is then selected, and the display token is inserted into the display window 40 such that it is visible through the wall 42 and/or opening 46 of the display window 40. As shown in FIG. 2, if the container 10 is at least partially submerged in hot or cold liquid, such as in water 62 in a buffet or steam table, the display token 52 remains in the display window 40 instead of floating out the open top end 43 thereof. When the goods 60 are depleted from the container 10, the container 10 can be removed from the table, whereby water that occupied the gap 44 flows out of the drainage channel 48 of the display window 40, and the display token 52 is removed by inverting the container 10. Advantageously, the display token 52 can be washed and reused for another application. Accordingly, a user is discouraged from adding products having a later expiration date to the container 10. Doing so would artificially reduce the stated lifespan of the later-added products, which may result in health code violations even though the later-added products are still fresh. Because adding another display token is not possible, and because adding new products on top of old is not advantageous, a user is more likely to dump the remaining products in the container and discard the container 10 and/or the display token 52 for cleaning.

In an alternative embodiment, goods having a predetermined lifespan are stored in the container 10, and a display token 52 associated with the production or “origination” date, i.e., the date when the goods were made or stored in the container, is inserted into the display window 40 such that it is visible through the wall 42 and/or opening 46 of the display window. Then, any goods left in the container longer than the predetermined lifespan from the indicated origination date would be considered spoiled and possibly a health code violation. It should be noted that the date on which the goods were produced is the date to be used for selecting the display token 52. As such, if goods made on Day 1 are not transferred to a container 10 until Day 2, the display token 52 corresponding to Day 1 should be used in order to truly reflect the production date of the goods.

As such, the present invention provides a significant advancement in food and other product storage by eliminating two significant health risks and common safety issues, namely, health code violations due to adhesive residue left on the outer surface of containers, and fraud due to misrepresentation of the expiration or spoilage date of food or other products stored inside the container. In addition, the present invention lowers cost by eliminating the need to replenish adhesive labels or stickers, as well as reducing the clutter and mess that are common to such labeling techniques. Further, the present invention increases the life span and attractiveness of containers by eliminating the need to use cleansers or solvents to remove adhesive residue left by labels or the like, which typically results in clouded or damaged containers, particularly if the container is formed from polycarbonate materials. The display token 52 of the present invention is reusable, does not float in water, and can be color-coded or the like in order to convey particular information about the food or other products stored inside the container 10. The display window 40 allows for quick reference to the expiration date or spoilage date of the food or other products stored inside the container. Advantageously, the display window 40 can be attached to a container or formed integrally therewith, yet does not hinder the stackability or other features that are common and expected in the art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, other shapes of containers are contemplated by the present invention, including cylindrical containers and the like. Although specific terms are employed herein, they are used in a generic and descriptive sense only and not for purposes of limitation.

1. A storage container, comprising:
a bottom wall;
a peripheral wall having inner and outer surfaces, the peripheral wall having a top end and a bottom end that adjoins the bottom wall, the peripheral wall and bottom wall defining a storage area; and
a display window extending from the outer surface of the peripheral wall, the display window having a wall spaced away from the outer surface of the peripheral wall to define a gap therebetween.

2. A storage container according to claim 1, wherein the peripheral wall defines a plurality of side walls, and wherein the display window extends from one of the side walls.

3. A storage container according to claim 1, wherein the peripheral wall extends from the bottom wall at a predetermined angle such that the container is stackable.

4. A storage container according to claim 3, wherein the peripheral wall includes a lip extending therefrom, the lip extending a distance greater than the wall of the display window from the outer surface of the peripheral wall.

5. A storage container according to claim 1, wherein the bottom wall, peripheral wall, and display window are each selected from at least one of the group consisting of stainless steel, aluminum, polyethylene, and polycarbonate.

6. A storage container according to claim 1, wherein the wall of the display window is at least partially transparent.

7. A storage container according to claim 1, wherein the wall of the display window defines an opening therethrough.

8. A storage container according to claim 1, wherein the display window defines at least one drainage channel in communication with the gap defined by the wall of the display window and the peripheral wall, the at least one drainage channel adapted for allowing liquid to pass therethrough.

9. A storage container according to claim 1, wherein the display window is attached to the peripheral wall.

10. A storage container according to claim 1, wherein the display window is integrally formed with the peripheral wall.

11. A storage container according to claim 1, wherein the wall of the display window and the peripheral wall define an angle therebetween.

12. A storage container according to claim 1, further comprising at least one additional display window extending from the peripheral wall.

13. A container system, comprising:
a bottom wall;
a peripheral wall having inner and outer surfaces, the peripheral wall having a top end and a bottom end that adjoins the bottom wall, the peripheral wall and bottom wall defining a storage area for receiving goods;
a display window extending from the peripheral wall, the display window having a wall spaced away from the peripheral wall to define a gap therebetween; and
at least one display token adapted for removable insertion into the gap defined by the display window and the peripheral wall, the at least one display token being visible through at least one of the wall of the display window and the peripheral wall.

14. A container system according to claim 13, wherein the at least one display token comprises seven tokens, each of the seven tokens corresponding to a respective day of the week.

15. A container system according to claim 13, wherein the display window is sized to accommodate only one display token in the gap.

16. A container system according to claim 13, wherein the at least one display token is reusable.

17. A container system according to claim 13, wherein the peripheral wall defines a plurality of side walls, and wherein the display window extends from one of the side walls.

18. A container system according to claim 13, wherein the peripheral wall extends from the bottom wall at a predetermined angle such that the container is stackable.

19. A container system according to claim 18, wherein the peripheral wall defines a lip extending therefrom, the lip extending a distance greater than the wall of the display window from the peripheral wall.

20. A container system according to claim 13, wherein the bottom wall, peripheral wall, display window, and at least one display token are each selected from at least one of the group consisting of stainless steel, aluminum, polyethylene, and polycarbonate.

21. A container system according to claim 13, wherein the wall of the display window is at least partially transparent such that the at least one display token can be seen therethrough.

22. A container system according to claim 13, wherein the wall of the display window defines an opening therethrough such that the at least one display token can be seen therethrough.

23. A container system according to claim 13, wherein the display window defines at least one drainage channel in communication with the gap defined by the wall of the display window and the peripheral wall, the at least one drainage channel adapted for allowing fluid to pass therethrough.

24. A container system according to claim 13, wherein the display window is attached to the peripheral wall.

25. A container system according to claim 13, wherein the display window is integrally formed with the peripheral wall.

26. A container system according to claim 13, wherein the at least one display token has a thickness of about 2 millimeters.

27. A container system according to claim 13, wherein the at least one display token has a shape selected from the group consisting of round, polygonal, and elliptical.

28. A container system according to claim 27, wherein the display window is shaped in a conforming arrangement with the shape of the at least one display token.

29. A container system according to claim 13, wherein the wall of the display window and the peripheral wall define an angle therebetween.

30. A container system according to claim 13, wherein the at least one display token comprises a plurality of tokens, each of the tokens having a unique identifier selected from the group consisting of color and text.

31. A container system according to claim 13, wherein the at least one display token is adapted to sink in water.

32. A container system according to claim 13, wherein the at least one display token is double-sided and has identification information on each side thereof.

33. A container system according to claim 13, wherein the container is adapted for storing food products, and wherein the at least one display token is adapted for indicating an production date of the food products.

34. A container system according to claim 13, wherein the top end of the peripheral wall includes a flange portion that extends outwardly, and wherein the display window extends from the flange portion of the peripheral wall.

35. A container system according to claim 13, further comprising at least one additional display window extending from the peripheral wall for receiving the at least one display token.

36. A method of storing goods, comprising:
storing the goods in a container;
selecting a display token corresponding to information pertaining to the goods; and
inserting the display token in a display window positioned on the container such that the display token is visible through at least one of the display window and the container.

37. A method according to claim 36, wherein the selecting step includes determining the goods' expiration date, and then selecting a color-coded display token corresponding to the goods' expiration date.

38. A method according to claim 36, wherein the inserting step includes inserting the display token in a gap defined between a wall of the display window and an outer surface of the container such that the display token is visible through the wall of the display window.

39. A method according to claim 36, further comprising at least partially submerging the container, display token, and display window in liquid, whereby the display token remains in the display window while submerged.

40. A method according to claim 36, wherein the selecting step includes selecting a display token corresponding to information pertaining to chemical goods stored in the container.

41. A method according to claim 36, wherein the selecting step includes selecting a display token corresponding to a date that the goods are produced.

42. A method according to claim 36, wherein the inserting step includes inserting a first display token in a first display window, the first display token corresponding to a production date of the goods, and inserting a second display token in a second display window, the second display token corresponding to an expiration date of the goods.
